(19) United States
(12) Patent Application Publication
(10) Pub. No.: US 2024/0266085 A1
(43) Pub. Date: Aug. 8, 2024

(54) Automated In-Vessel Neutron Flux Detector System Embedded in Control Drum Assembly

(71) Applicant: Westinghouse Electric Company LLC, Cranberry Township, PA (US)

(72) Inventors: Jeffrey L. ARNDT, Pittsburgh, PA (US); Jorge V. CARVAJAL, Irwin, PA (US); Thomas TWEEDLE, Sewickley, PA (US)

(73) Assignee: Westinghouse Electric Company LLC, Cranberry Township, PA (US)

(21) Appl. No.: 18/164,964

(22) Filed: Feb. 6, 2023

(51) Int. Cl. G21C 17/108; G01T 3/00; G21C 7/26

(52) U.S. Cl. CPC G21C 17/108; G01T 3/00; G21C 7/26

(57) ABSTRACT

A measurement device for determining a power level of a nuclear reactor core is provided, the measurement device comprising an in-vessel detector assembly. The in-vessel detector assembly comprises a rotatable housing defining a cavity therein and a detector element positioned in a first angular portion of the cavity of the housing. A control drum for a nuclear reactor core and a system for monitoring a power level of a nuclear reactor are also provided.

### BACKGROUND

Advanced nuclear reactors employing small footprints and low power designs relative to conventional designs can be transported to remote locations and deployed therein to generate power onsite. In order to operate nuclear reactors in a safe manner, the neutron flux therein must be monitored accurately and timely to provide adequate control of the reactor power output levels. Since neutron flux in a nuclear reactor is directly proportional to a power output thereof, these relatively low power advanced nuclear reactors require sensitive neutron flux detection systems to accurately portray neutron flux levels and spatial distributions thereof within the reactor vessels. Conventional detection devices can be inserted into fuel assemblies of nuclear reactors to provide measurements of neutron flux throughout a range of power output levels. However, an incorporation of the retractable assemblies into the advanced nuclear reactors would significantly increase the overall size thereof, thereby compromising portability. Fixed detection devices and methods can require frequent replacement and/or maintenance intervals and thus, compromise reactor operating efficiency. Therefore, a need exists to develop alternative measurement devices and systems to optimize the efficiency and safety of operating advanced nuclear reactors without compromising the portability thereof.

### SUMMARY

The following summary is provided to facilitate an understanding of some of the innovative features unique to the aspects disclosed herein and is not intended to be a full description. A full appreciation of the various aspects disclosed herein can be gained by taking the entire specification, claims, and abstract as a whole.

In various aspects, a measurement device for determining a power level of a nuclear reactor core is disclosed. In some aspects, the measurement device includes an in-vessel detector assembly. In some aspects, the in-vessel detector assembly includes a housing defining a cavity therein and a detector element. In some aspects, the housing is configured to be rotatable in place; the cavity of the housing includes a first angular portion; and a rotational range of the housing includes a number of angular sectors. In some aspects, the detector element is positioned in the first angular portion of the cavity of the housing and is configured to be responsive to a neutron flux upon an angular displacement of the first angular portion towards a first angular sector of the rotational range of the housing.

In various aspects, a control drum for a nuclear reactor core is disclosed. In some aspects, the control drum includes a rotatable housing comprising a neutron absorber section and one or more detector elements configured to be responsive to a neutron flux. In some aspects, the rotatable housing is configured to rotate within a rotational range comprised of a number of angular sectors and the neutron absorber section is positioned within a first angular portion of the rotatable housing. In some aspects, the one or more detector elements are housed within the first angular portion of the rotatable housing.

In various aspects, a system for monitoring a power level of a nuclear reactor is disclosed. In some aspects, the system includes a plurality of in-vessel detector assemblies. In some aspects, each of the in-vessel detector assemblies includes a neutron flux detection portion responsive to a source range neutron flux, an intermediate range neutron flux or a combination thereof; and each of the in-vessel detector assemblies is independently configured to be rotated in place through a rotational range by a control drum drive of the nuclear reactor, each rotational range including a number of angular sectors. In some aspects, the system is configured to independently determine a rotation of each of the in-vessel detector assemblies based on a neutron flux level within the nuclear reactor. In some aspects, a rotation of an in-vessel detector assembly includes an alignment of the neutron flux detection portion thereof with one of the angular sectors of the rotational range of the in-vessel detector assembly.

These and other objects, features, and characteristics of the present disclosure, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of any of the aspects disclosed herein.

### BRIEF DESCRIPTION OF THE DRAWINGS

The various aspects described herein, together with objects and advantages thereof, may best be understood by reference to the following description, taken in conjunction with the accompanying drawings as follows.

FIG. 1 is a graphical depiction of ranges of thermal power produced by a nuclear reactor, according to at least one non-limiting aspect of the present disclosure.

FIG. 2 illustrates a cross-sectional view of a reactor vessel, according to at least one non-limiting aspect of the present disclosure.

FIG. 3 is a cross-sectional schematic representation of a measurement device, according to at least one non-limiting aspect of the present disclosure.

FIG. 4 is a cross-sectional schematic representation of a housing, in accordance with at least one non-limiting aspect of the present disclosure.

FIG. 5 is a schematic representation of a rotational range, in accordance with at least one non-limiting aspect of the present disclosure.

FIG. 6 illustrates a perspective view of a control drum according to at least one non-limiting aspect of the present disclosure.

FIG. 7 is a cross-sectional schematic representation of a system for monitoring a power level of a core of a nuclear reactor, in accordance with at least one non-limiting aspect of the present disclosure.

FIG. 8 is a cross-sectional schematic representation of a system for monitoring a power level of a core of a nuclear reactor, in accordance with at least one non-limiting aspect of the present disclosure.

FIG. 9 is a cross-sectional schematic representation of a system for monitoring a power level of a core of a nuclear reactor, in accordance with at least one non-limiting aspect of the present disclosure.

FIG. 10 is a cross-sectional schematic representation of a system for monitoring a power level of a core of a nuclear reactor, in accordance with at least one non-limiting aspect of the present disclosure.

Corresponding reference characters indicate corresponding parts throughout the several views. The exemplifications set out herein illustrate various aspects of the present disclosure, in one form, and such exemplifications are not to be construed as limiting the scope of any of the aspects disclosed herein.

### DETAILED DESCRIPTION

Certain exemplary aspects of the present disclosure will now be described to provide an overall understanding of the principles of the composition, function, manufacture, and use of the compositions and methods disclosed herein. An example or examples of these aspects are illustrated in the accompanying drawing. Those of ordinary skill in the art will understand that the compositions, articles, and methods specifically described herein and illustrated in the accompanying drawing are non-limiting exemplary aspects and that the scope of the various examples of the present disclosure is defined solely by the claims. The features illustrated or described in connection with one exemplary aspect may be combined with the features of other aspects. Such modifications and variations are intended to be included within the scope of the present disclosure.

Reference throughout the specification to “various examples,” “some examples,” “one example,” “an example,” or the like, means that a particular feature, structure, or characteristic described in connection with the example is included in an example. Thus, appearances of the phrases “in various examples,” “in some examples,” “in one example,” “in an example,” or the like, in places throughout the specification are not necessarily all referring to the same example. Furthermore, the particular features, structures, or characteristics may be combined in any suitable manner in an example or examples. Thus, the particular features, structures, or characteristics illustrated or described in connection with one example may be combined, in whole or in part, with the features, structures, or characteristics of another example or other examples without limitation. Such modifications and variations are intended to be included within the scope of the present examples.

In the following description, like reference characters designate like or corresponding parts throughout the several views of the drawings. Also in the following description, it is to be understood that such terms as “forward,” “rearward,” “left,” “right,” “above,” “below,” “upwardly,” “downwardly,” and the like are words of convenience and are not to be construed as limiting terms.

In a nuclear reactor core, fissile fuels such as, for example, uranium-235 (sometimes referred to hereinafter as “²³⁵U”) interact with an incident neutron flux and upon absorbing an appropriately energetic neutron, can subsequently fission into a number of lighter nuclei fission products and/or fragments, thereby generating an emission of prompt neutrons. These prompt neutrons can subsequently be absorbed by other nuclei to propagate another fission event, and so on and so forth. The lifetime of a prompt neutron occurs from the time it is emitted by a fission event to the time that it is absorbed by another nuclei.

The average number of neutrons originating from a first fission event that subsequently initiate another fission event can be quantified by a neutron multiplication factor k_{eff}. Generally, k_{eff} represents the ratio of neutrons in a generation to the number of neutrons in a previous generation be quantified as a neutron multiplication factor k_{eff}. Thus, a k_{eff} of a reactor can be indicative of the power produced thereby. In a subcritical reactor where k_{eff}<1, the fission reactions must be initiated with the aid of an auxiliary neutron source. In a critical reactor, k_{eff}=1 and thus, neutrons are produced and consumed in a self-propagating chain reaction. In a supercritical reactor where k_{eff}>1, the rate of neutrons produced exceeds the neutrons consumed. The excess reactivity in a supercritical reactor can quickly grow in an uncontrollable manner if the reactor conditions are inadequately controlled.

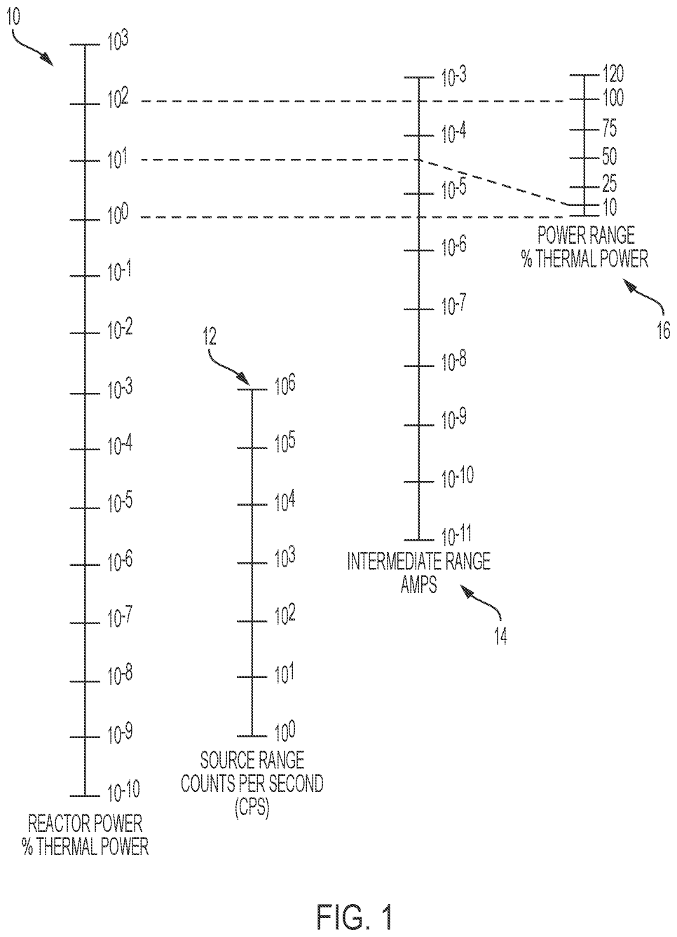

A neutron flux produced within a nuclear reactor vessel containing a reactor core assembly is indicative of the power output of the nuclear reactor, such as, for example, thermal power measured in megawatts thermal (MWt) or electrical power measured in megawatts electric (MWe). Generally, a range of thermal power produced by the nuclear reactor can be segmented into various ranges of reactivity. For example, FIG. 1 depicts an overall range 10 of thermal power produced by a reactor, according to at least one non-limiting aspect of the present disclosure. The overall range 10 is measured in percent thermal power and is segmented into a source range flux 12 measured in counts per second, an intermediate range flux 14 measured in amps, and a power range flux 16 measured in percent thermal power. Each of the flux ranges 12, 14 and 16 are respectively provided in terms of their conventionally employed unit systems. However, the depicted values of flux in ranges 12 and/or 14 common with values in the overall range 10 are depicted in FIG. 1 to be in vertical alignment.

In the context of an operating nuclear reactor, the transitions between different reactivity conditions can occur with very small changes in reactor power level due to the self-amplifying tendencies of fissile fuel reactions. Thus, each of the reactivity ranges must be carefully and deliberately traversed in during startup and/or shutdown procedures to meet the power demands therefrom in a safe manner. For example, a startup sequence of a reactor core can include slow increases in reactivity through the source range, followed by the intermediate range. Generally, the k_{eff} of a nuclear reactor is maintained in a critical state during operation to produce a constant power output. Since the stability of a reactor is highly sensitive to fluctuations in operating conditions, excessive changes to bring a reactor into and/or out of a power range can cause unintended secondary effects, such as, for example, rapid transitions from subcritical to supercritical states leading to reactor instability and/or runaway, which can be very difficult to recover from. Additionally, a reactor core can continue to generate a significant amount of heat after shutdown due to a production of delayed neutrons which may cause unforeseen increases in reactivity if not properly monitored in a dormant reactor. Accordingly, nuclear reactors generally require accurate power monitoring regardless of operating state.

A reactivity control system decreases and/or slows neutron production via displacement of a neutron absorbing element into the reactor core. For example, in a conventional pressurized water reactor (PWR), long retractable control rods comprised of burnable absorber materials are inserted through vessel walls into the fuel assemblies of the reactor core to decrease reactivity. In order to make timely and precise adjustments of neutron absorbing elements, reactivity control systems rely on feedback from nuclear instrumentation, such as, for example, excore detector assemblies comprised of source range detectors, intermediate range detectors, and/or power range detectors, and/or incore detector assemblies comprising source range and/or intermediate range detectors.

Many neutron detectors are comprised of a material having a neutron cross-section substantial enough to absorb and/or interact with an incident neutron flux to indirectly produce a measurable flux of charged particles and/or electrical current, which can then be employed by accompanying hardware to produce an observable response signal. Generally, a neutron detector's ability to provide accurate measurements is limited by a measurement sensitivity thereof. For example, neutron detectors intended for measuring source range and/or intermediate range fluxes are generally configured with higher neutron cross-section materials, and thus a higher measurement sensitivity, than power range detectors. Therefore, a response signal produced by a source range detector, an intermediate range detector and/or an incore detector assembly may become saturated when exposed to a neutron flux higher in magnitude than originally designed for. Likewise, power range detectors may not provide the sensitivity required to be responsive to lower range fluxes.

Conventional incore detector assemblies comprising source range and/or intermediate range detectors are axially inserted into a reactor core through penetrations in the top and/or bottom of the reactor vessel to provide source range and/or intermediate range measurements therein and/or spatial distributions thereof during shutdown and startup conditions. However, the high sensitivity detector configurations thereof are susceptible to burnup when exposed to power range fluxes. Thus, conventional incore detector assemblies are retracted during higher power conditions and stored in an excore low radiation field to maintain the useful service life thereof.

In contrast, excore detector assemblies are fixed outside of a reactor vessel and around a reactor core to detect leakage neutrons which can be indicative of overall reactor power output. Accordingly, excore detector assemblies can provide the advantage of easy maintenance and implementation due to their positioning, but may not provide the signal resolution of incore detector assemblies required to accurately assess spatial power distributions. Thus, a reactivity control system generally requires more than one type of neutron detector to reliably control a power output of a nuclear reactor.

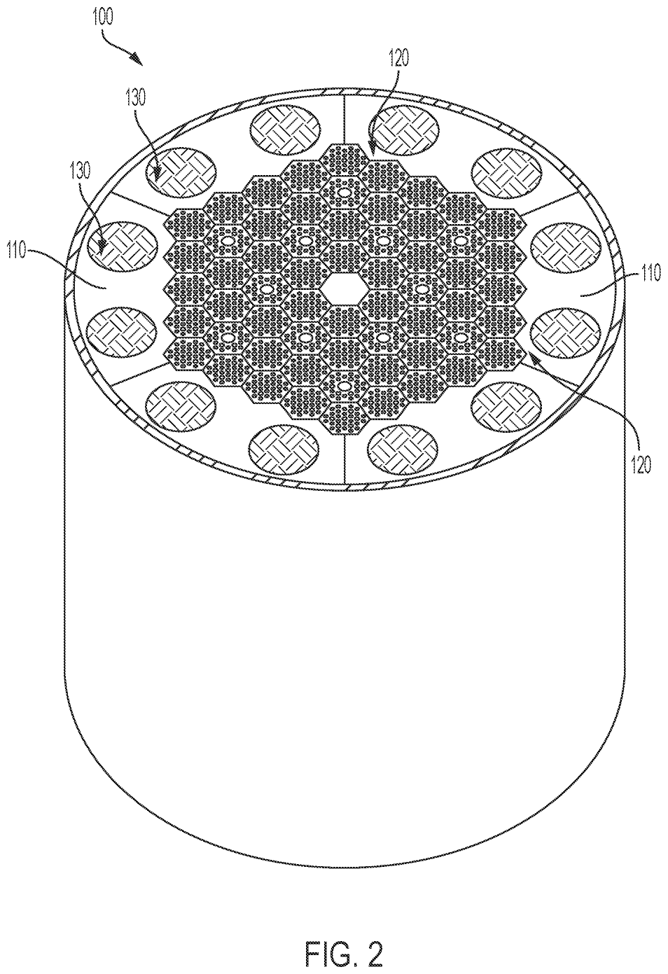

Advanced nuclear reactor designs, such as, for example, nuclear microreactors, employing smaller scale architectures than traditional PWRs, in both size and power output, are emerging as a solution for providing a reliable off-grid power source. For example, the eVinci™ microreactor currently being developed by Westinghouse is comprised of a microreactor vessel built into a dedicated container as an integral package. The space between the microreactor vessel and the container is minimized to provide a preassembled package having a footprint that is optimized for transportation via truck to a final destination. A perspective view of a microreactor vessel 100 cross-section is provided in FIG. 2, in accordance with at least one non-limiting aspect of the present disclosure. The reactor vessel 100 includes a radial reflector 110, a central core 120 including fuel assemblies, and non-instrumented control drums 130. The radial reflector 110 prevents leakage neutrons from emanating through the vessel 100, thereby maximizing neutron economy within the vessel 100. Motion control systems are also included for rotating the non-instrumented control drums 130. Thus, the microreactor vessel 100 can maximize the potential power output therefrom while maintaining a space saving geometry. Other example microreactors and operation methods thereof are described in further detail in U.S. patent application Ser. No. 17/084,365 and in U.S. patent application Ser. No. 18/057,208, each of which is owned by the Applicant of the present disclosure, and each of which is herein incorporated by reference in its entirety.

An effective management of excess reactivity and spatial neutron flux distribution in a microreactor can be challenging due to the space constraints between the reactor vessel and the container. For example, excore instrumentation and control (“I&C”) systems dedicated to axially displacing a conventional movable incore detector assembly can occupy a significant amount of space extending from the vessel surface. Thus, an implementation of conventional movable incore detector assemblies in a microreactor can substantially enlarge an overall footprint of the container, thereby compromising the portability of the microreactor. Furthermore, the conventional incore detector assemblies would need to be fully retracted from the microreactor vessel 100 during power operation to avoid detector burnup, thereby increasing the space requirements for a designated microreactor installation area.

In an attempt to circumvent the issues related to conventional movable incore detector assemblies, fixed incore detector assemblies that are more resistant to burnup when exposed to a power range neutron flux have been developed to provide accurate measurements during startup and/or shutdown sequences. However, material properties of these fixed incore detector assemblies irreversibly change over time in a neutron rich environment. Additionally, the fixed incore detector assemblies can suffer from burnup in the long term during operation by the end of a planned lifetime of the fuel assembly of eight years, for example. Accordingly, fixed incore detector assemblies can require frequent calibration, service and/or replacement thereof during the planned lifetime of fuel assembly of a microreactor to maintain source range measurement accuracy, thereby complicating operation of the microreactor.

Moreover, the radial reflector 110 intentionally reduces the neutron field strength surrounding the vessel 100 to a lower level during power operation. Thus, a neutron flux produced within the vessel 100 during startup and/or shutdown states, wherein neutron field strengths surrounding the vessel 100 are orders of magnitude lower than during power operation, would be substantially undetectable with a conventional excore detector assembly, regardless of the measurement sensitivity thereof.

While a microreactor packaged in a transportable container can provide the benefits of smaller size, increased portability and/or higher neutron efficiency when compared to conventional nuclear reactor designs, the instrumentation and equipment for managing reactivity therein can be difficult to implement without increasing the overall size of the container, compromising flux measurement accuracy, and/or decreasing the operational efficiency of the microreactor. Accordingly, various aspects of the present disclosure provide various methods and devices for measuring various ranges of neutron flux within a reactor core of a microreactor, for example, and maintaining high measurement accuracy and/or operational efficiency over the planned lifetime of a fuel assembly.

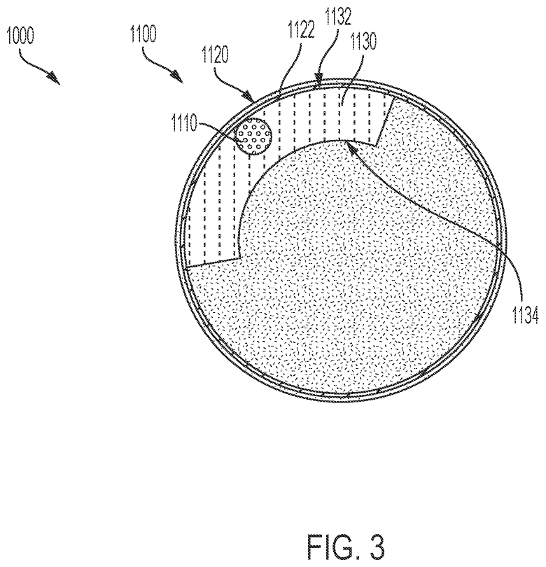

Now referring to FIG. 3, a cross-sectional schematic representation of a measurement device 1000 for determining a power level of a nuclear reactor core is provided, in accordance with at least one non-limiting aspect of the present disclosure. The measurement device 1000 includes an in-vessel detector assembly 1100 comprising a detector element 1110 and a housing 1120. In various examples, the detector element 1110 is configured to be responsive to a source range and/or intermediate range incident neutron flux. In some examples, the detector element 1110 is comprised of a material having a thermal neutron cross-section greater than 1 barn, or greater than about 5 barns, or greater than about 10 barns, or greater than about 25 barns, or greater than about 50 barns, or greater than about 75 barns, or greater than about 100 barns, or on the order of about 1000 barns. In certain examples, the detector element 1110 can include a ²³⁵U fission chamber, a boron trifluoride (BF₃) proportion counter, a boron-lined compensated ion chamber, an uncompensated ion chamber, a Vanadium and/or Rhodium Self-powered Neutron Detector (SPND), a solid state neutron detector or combinations thereof. Other configurations are contemplated by the present disclosure. For example, in some implementations, the detector element 1110 can be configured to indirectly and/or directly interact with gamma radiation, epithermal neutrons and/or fast neutrons.

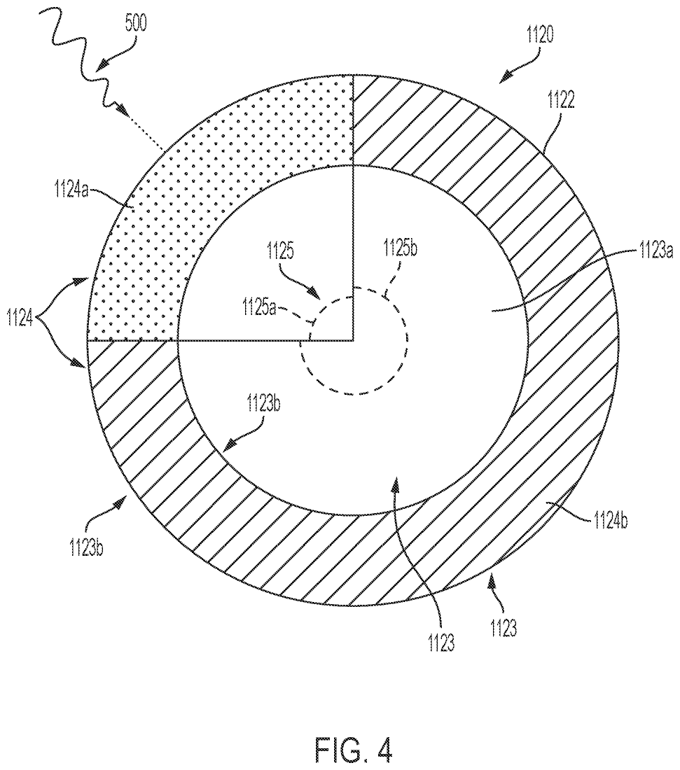

FIG. 4 provides a cross-sectional schematic representation of a housing 1120 according to at least one non-limiting aspect of the present disclosure. In various examples, the outer surface of the in-vessel detector assembly 1100 is defined by an outer wall 1122 of the housing 1120 and the outer wall 1122 defines a cavity therein. The in-vessel detector assembly 1100 is configured to fit within a cavity of a radial reflector. For example, an outer wall 1122 of the housing 1120 can be configured with a cylindrical geometry having an outer diameter slightly smaller than a diameter of a cavity for a control drum. In some examples, the housing 1120 has an outer diameter substantially the same as a control drum of a microreactor. In certain examples, the housing 1120 can have a length substantially the same as the length of a cavity for a control drum. Thus, the housing 1120 can be configured to be retrofitted into a microreactor vessel and/or replace a control drum therein. Other configurations of the housing 1120 are contemplated by the present disclosure. For example, the housing 1120 can be configured with a hexagonal cross-section, an ovalized cross-section, or a lobed cross-section, circumscribable in a circular cross-section geometry having an outer diameter slightly smaller than a diameter of a cavity for a control drum and/or can be a modular sublength section having a length substantially the same as a length of a modular unit cell and/or reflector section of a 200 MWth modular reactor vessel.

Still referring to FIG. 4, the cross-sectional geometry of the cavity defined by an outer wall 1122 can be radially partitioned into two or more nested concentric radial sectors 1123. For example, in a cylindrically configured outer wall 1122, the cross-section geometry of the cavity defined therein can be radially partitioned into an inner radial sector 1123a comprised of a circular region having a smaller diameter than the outer wall 1122 and an outer annular radial sector 1123b surrounding the inner radial sector. In some examples, the cavity includes one or more radial sectors sandwiched between an inner radial sector and an outer radial sector.

Additionally, the cross-sectional geometry of the cavity defined by an outer wall 1122 is partitioned into two or more angular portions. For example, in a cross-section geometry of a cylindrically configured outer wall 1122, an angular portion 1124 is defined as a region where a circular segment defined by a central angle 1125 and one or more radial sectors 1123 overlap. A circular segment overlapping only an outer radial sector 1123b will result in an angular portion having both inner and outer radial surfaces. In contrast, a circular segment overlapping a region including an inner radial sector 1123b will result in an angular portion having an inner point at the center of the cavity. The arrangement of each of the angular portions 1124 in relation to each other and to the housing 1120 is static and therefore, a rotation of the housing 1120 will rotate all of angular portions around the center of the housing 1120 accordingly.

In various examples, the cavity includes a first angular portion 1124a defined by a first central angle 1125a and having a radially outer surface abutting the perimeter of the cavity cross-section and a radially inner surface. In some examples, the cavity includes a second angular portion 1124b defined by a second central angle 1125b greater than the first central angle 1124a. In certain examples, a central angle 1125a is less than 180°, or less than 120°, or about 90°, or about 60°. Other configurations are contemplated by the present disclosure. For example, in some implementations, the cavity can be partitioned into quadrants, sextants, octants, or any other number of equivalently sized angular portions, radial portions thereof, and or a combination thereof.

It shall be appreciated that the use of the terms “radial” and “angular”, as used in the present disclosure in connection with a cross-sectional geometry of a cavity defined by a housing, describes, respectively, any direction extending from the center of the housing in an axial plane defining the cross-section and any angle within the plane having the center of the housing as an apex. Accordingly, the use of the terms “radial” and “angular” shall not be limited to circular or circular-like configurations and shall not be construed to imply that the radial sectors 1123 and angular portions 1124 of FIG. 4 are limited to circular, or circular-like, configurations. For example, the present disclosure contemplates non-limiting aspects in which the radial sectors 1123 and/or angular portions 1124 include a polygonal configuration. Accordingly, to such aspects, the cavity of the housing 1120 can include combinations of dissimilar geometries including polygonal inner and/or outer radial sectors, angular portions thereof, or any combination thereof with a circular radial sector. Additionally, while the radial sectors 1123 and/or angular portions 1124 as described hereinabove refer to spatial relationships within a cavity, other configurations of the housing 1120 contemplated by the present disclosure can define physically separated subcavities therein. Accordingly, in some implementations, the cavity of a housing 1120 can be divided into subcavities with structural members positioned according to the radial sectors 1123 and/or angular portions 1124, as described hereinabove.

For the purposes of describing an orientation of angular portion 1124 relative to a radiation source, an angular alignment therewith will be based on half of the central angle 1125 associated therewith. For example, as depicted in FIG. 4, an angular alignment of an angular portion 1124 with a neutron source will be realized when the midpoint of the outer radial surface of the angular portion 1124, corresponding to half of the central angle, is directly facing an incident neutron flux 500 propagating from the neutron source.

Further to the above, the housing 1120 is configured to be rotatable in place. For example, an end portion of the housing 1120 can be configured to receive a torque through a driveshaft or transmission output of a drive. As used herein, the phrase “rotatable in place” refers to angular motion without a translatory and/or linear motion thereof. Thus, a housing 1120 incorporating this configuration can be rotated within a cavity without a removal therefrom. In some examples, the housing 1120 includes an axially oriented shaft coupler configured to interface with an existing control drum drive hardware of a reactivity control system. A housing 1120 incorporating this configuration can be driven by a preexisting control drum drive and/or motion control system upon an insertion thereof into a control drum cavity. Accordingly, in some aspects, the in-vessel detector assembly 1100 can be configured to be retrofitted into a control drum based reactivity control system without requiring a dedicated I&C system.

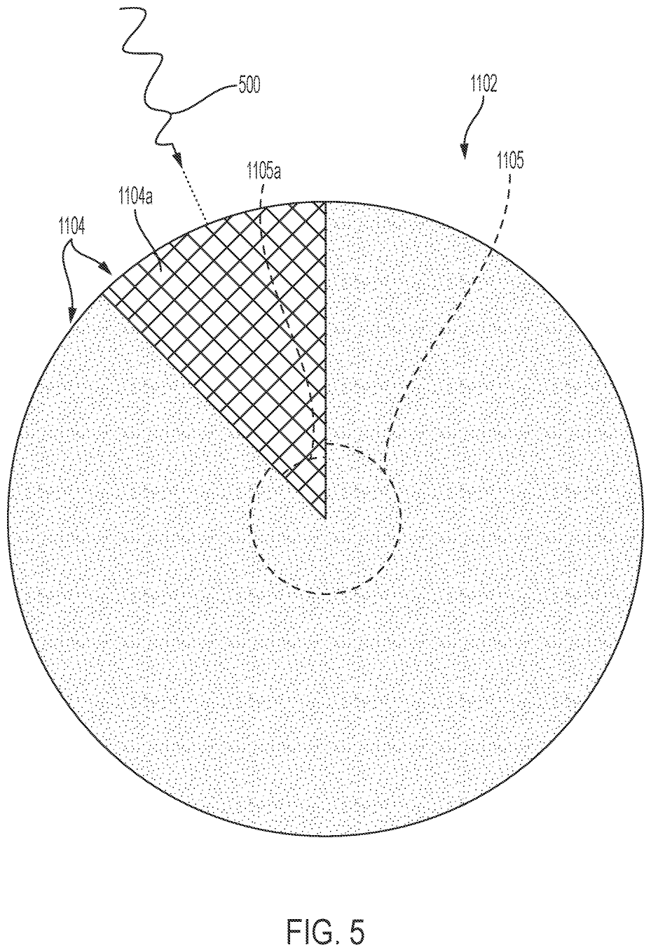

Now referring to FIG. 5, a schematic representation of a rotational range 1102 of a housing 1120 is provided, in accordance with at least one non-limiting aspect of the present disclosure. The rotational range 1102 is comprised of a number of angular sectors 1104 independently defined by a central angle 1105, and a summation thereof represents the total angle swept by an entire rotational range of the housing 1120. In various examples, the rotational range 1102 includes a first angular sector 1104a. In some examples, the rotational range 1102 can originate from a first angular sector 1104a and have a span of about 180° or more. and comprise two or more equally sized angular sectors 1104. In certain examples, a first central angle 1105a is about 30°, or about 45°, or about 60°, or about 90°, or about 120°. In one example, each of the angular sectors 1104 are equally sized.

For the purposes of describing an orientation of angular sectors 1104 relative to a radiation source, an angular alignment therewith will be based on half of the central angle 1105 associated therewith. However, in contrast to radial sectors 1123 and angular portions 1124 as described hereinabove, the rotational range 1102, and angular sectors 1104 thereof, are not to be construed as a structural characteristic. Rather, the rotational range 1102 defines a path and/or a number of stationary regions through which a housing 1120, or a region defined therein, may traverse upon a rotation of the housing 1120. For example, when a first angular sector 1104a is in alignment with an incident neutron flux 500 as depicted in FIG. 5, a first angular portion 1124a can be brought into a first position in alignment with the first angular sector 1104a upon an appropriate rotation of the housing 1120. Upon a subsequent 180° rotation of the housing 1120 into a second angular sector 1104b, the first angular portion 1124a will be in greatest misalignment with the first angular sector 1104a the incident neutron flux aligned therewith. Thus, the rotational range 1102 and the angular sectors 1104 can be used a reference indicating an extent of rotation and/or a rotational state of a housing, to thereby indicate an orientation of the housing 1120 relative to a neutron source and any implications thereof. Accordingly, in some aspects, the rotational range 1102 can be configured to provide reference points and/or setpoints in an I&C system for rotating the housing 1120.

Now referring to FIGS. 3-4, the housing 1120 can be configured to interact with an incident neutron flux. For example, a portion of the housing 1200 can include a neutron absorber 1130 comprised of a material having a high neutron absorption and/or neutron scattering cross-section. The length of the neutron absorber 1130 is configured to be substantially the same as the housing 1120. In various examples, the neutron absorber 1130 includes a radially outer surface 1132 and a radially inner surface 1134. In some examples, the neutron absorber 1130 is comprised of boron, gadolinium, beryllium oxide, graphite, or a combination thereof. In certain examples, the neutron absorber 1130 comprises multiple layers. In one example, the neutron absorber comprises multiple layers. A neutron absorber 1130 incorporating this configuration can absorb an incident neutron flux.

The neutron absorber 1130 is positioned within the cavity of a housing 1120. For example, the neutron absorber 1130 can positioned in a first angular portion 1124a. In some examples, the neutron absorber 1130 is in direct contact with an outer wall 1122 of the housing 1120. In certain examples, the neutron absorber 1130 comprises an entire region defined by the first angular portion 1124a.

When a radially outer surface 1132 of a neutron absorber 1130 is in direct view of a neutron source, the neutron absorber 1130 can absorb and/or dissipate an incident neutron flux therefrom, thereby decreasing a further propagation of the neutron flux. Thus, upon an insertion of the in-vessel detector assembly 1100 into an existing reactor vessel, an alignment of the first angular portion 1124a and a neutron detector 1130 therein with an incident neutron flux from a fuel assembly, for example, can prevent the neutron flux from interacting with surrounding structures, such as, for example, a radial reflector assembly of a nuclear reactor vessel, thereby decreasing a reactivity within the reactor core. Additionally, when the housing 1120 is rotated to expose a radially inner surface 1134 of the neutron absorber to a neutron source, a portion of the neutron flux produced thereby can be reflected back to the neutron source while a remaining portion of the neutron flux bombards the radially inner surface 1134 and is subsequently absorbed thereby preventing a further propagation thereof into the radially outer surface 1132 and/or any regions thereabouts. Accordingly, the first angular portion 1124a can be rotated out of alignment with a neutron source to minimize a neutron absorber's 1130 effect on a surrounding neutron population and/or shield a region abutting the radially outer surface 1132.

Still referring to FIGS. 3-4, the detector element 1110 is affixed to the housing 1120. For example, the detector element 1110 can be affixed to a portion of the housing 1120 defined by an angular portion 1124. In various examples, the detector element 1110 is positioned within a first angular portion 1124a. In some examples, the detector element 1110 is flush with and/or embedded slightly under an outer surface of the housing 1120. Thus, a distance and/or positioning of the detector element 1110 relative to a point of reference external to the housing 1120 can be controlled via a rotation of the housing 1120. Additionally, the detector element 1110 can be positioned along a length of the housing 1120 as desired. For example, an axial positioning of the detector element 1110 can be configured to be in alignment with an expected neutron flux upon an insertion of the in-vessel detector assembly 1100 into a cavity of a radial reflector. Other configurations are contemplated by the present disclosure. For example, in an alternative embodiment, an in-vessel detector assembly 1100 can include multiple detector elements located at various axial and/or angular positions, and/or independently configured to be responsive to a source range and/or intermediate range neutron flux.

In examples where a neutron absorber 1130 is positioned in a first angular portion 1124a, the detector element 1110 can be affixed to the neutron absorber 1130. For example, the detector element 1110 can be flush with and/or embedded just within an outermost radial portion of the first angular portion 1124a and/or a radially outer surface 1132 of a neutron absorber 1130. In some examples, the detector element 1110 is embedded within a depression extending radially inwards from the outer wall 1122 of the housing 1120 towards and/or into the radially outer surface 1132 of the neutron absorber 1130. A detector element 1110 incorporating this configuration can conditionally interact with an incident neutron flux. For example, when the housing 1120 is rotated so that a first angular portion 1124a, and a detector element 1110 therein, is in alignment with a neutron source, an incident neutron flux propagating therefrom will be able to interact with and/or bombard the detector element 1110 without needing to overcome any significant obstructions therebetween. Upon a sufficient rotation of the housing 1120 to orient the first angular portion 1124a away from neutron source, the radially inner surface 1134 of the neutron absorber 1130 will be in direct view of the neutron source and will inhibit and/or decrease a further propagation of an incident neutron flux therefrom towards the radially outer surface 1132 and/or the detector element 1110. Thus, the in-vessel detector assembly 1100 can be configured to conditionally allow and/or interrupt an interaction between a detector element 1110 and an incident neutron flux based on a rotational state of the housing 1120 and/or the positioning of the detector element 1110 in a reactor vessel, which can be provided by a preexisting instrumentation and control system for a control drum. Accordingly, in some aspects, upon an insertion into a vessel of a nuclear reactor core, the in-vessel detector assembly 1100 can be configured to provide multiple modes of operation independent of axial positioning without requiring a dedicated control system and/or mechanism, thereby avoiding operational and/or transportation issues associated with a conventional retractable detector assembly.

Further to the above, the neutron absorber 1130 can have a maximum thickness of at least 500 microns, or at least 1 millimeter, or at least 1 centimeter, or about 5 centimeters. In some examples, the neutron absorber 1130 has a uniform thickness. In certain examples, the neutron absorber 1130 can span an entire axial length of a housing 1120. Other configurations are contemplated by the present disclosure. For example, in some implementations, a thickness of the neutron absorber 1130 can be configured with a variable thickness and/or a symmetric reduction in thickness towards the edges of the neutron absorber.

The thickness and/or composition of the portion of the neutron absorber 1130 backing a detector element 1110, determined as a radial distance between the detector element 1110 and the radially inner surface 1134, can be configured to increase a neutron shielding effect on the detector element 1110 and/or minimize burnup thereof, when appropriately oriented in relation to a neutron source as described hereinabove. For example, a ratio of the thickness of the portion of the neutron absorber 1130 radially backing a detector element 1110 to the thickness of the detector element 1110 can be about 20:1, or about 15:1, or about 10:1, or about 9:1, or about 8:1. or about 7:1, or about 6:1, or about 5:1, or about 4:1, or about 3:1, or about 2:1, or greater than about 1:1. In some examples, a portion of the neutron absorber 1130 backing the detector element 1110 is comprised of a material having an average thermal neutron cross-section of at least 10 barns, or at least 15 barns, or at least 20 barns, or at least 30 barns, or at least 50 barns, or at least 100 barns, or at least 500 barns, or on the order of 1000 barns, or on the order of 100,000 barns. In certain examples, the neutron absorber 1130 can comprise one or more layers of a boron-10 based material and/or a gadolinium-157 based material. A neutron absorber 1130 incorporating this configuration can shield a detector element 1110 from any unnecessary exposure to a high power neutron flux, such as, for example, power range neutrons in a 3 MWe and/or 15 MWt reactor operating at up to 120% full power or in small modular reactors having outputs of up to 200 MWt, over a period of 8 or more years, thereby decreasing the frequency of calibration, service and/or replacement of the detector element 1110 due to an exposure thereof to excessively high power neutron radiation. Thus, in some aspects, the in-vessel detector assembly 1100 can be configured to remain in a stationary standby state to preserve a detector element 1110 in a reactor vessel during high power conditions for a planned operating lifetime of a nuclear fuel assembly, thereby providing readily available lower power measurements required to safely control the reactor core during transitions into startup and/or shutdown states of the nuclear reactor while maintaining a source range and/or intermediate range measurement sensitivity of the detector element 1110. Accordingly, the in-vessel detector assembly 1100 can be configured to extend the service life of a detector element 1110, thereby providing the benefit of safety, reliability, and/or operational efficiency when implementing the measurement device 1000 in a nuclear reactor, such as, for example, a microreactor.

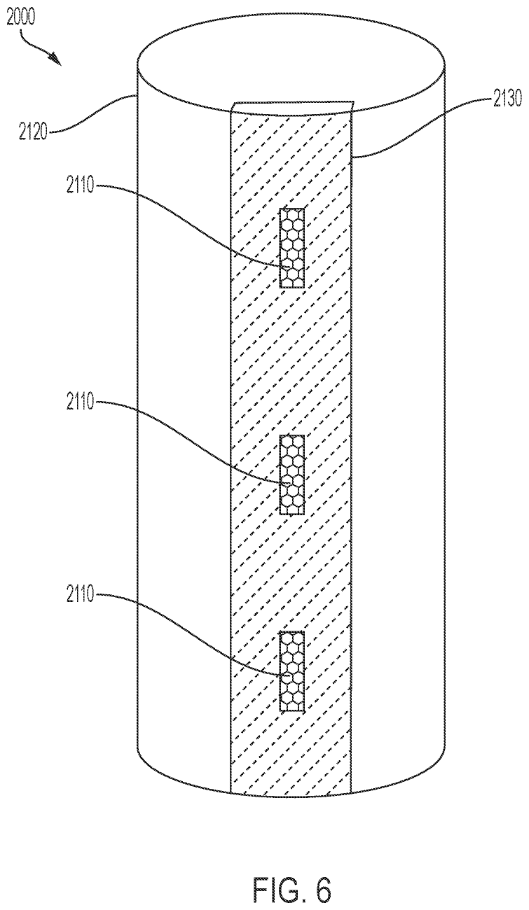

FIG. 6 provides a perspective view of a control drum 2100 for a nuclear reactor core according to at least one non-limiting aspect of the present disclosure. The control drum 2100 includes a rotatable housing 2120 comprising a neutron absorber section 2130 and one or more detector elements 2110 configured to be responsive to a neutron flux. The rotatable housing 2120 and each of the detector elements 2110 of the control drum 2100 are similar in many respects to, respectively, other housings and detector elements described elsewhere in the present disclosure which are not repeated for the sake of brevity. In various examples, the rotatable housing 2120 is configured with a cylindrical cross-section geometry comprising two or more angular portions independently defined by a central angle, and an outer radial sector. A radially outer surface of the neutron absorber section faces away from the radial center of the rotatable housing while a radially inner surface faces inward. In some examples, the control drum includes a plurality of detector elements.

The rotatable housing 2120 and the neutron absorber section 2130 can be configured similarly to, respectively, a housing 1120 and a neutron absorber 1130 as described hereinabove. Thus, the rotatable housing 2120 can be configured to rotate through a rotational range defined by a number of angular sectors while remaining within a control drum cavity. The neutron absorber section 2130 can be positioned within a first angular portion of the rotatable housing comprising a region of a circular sector overlapping with the outer radial sector. The first angular portion of the rotatable housing is configured to house the one or more detector elements.

Further to the above, the rotatable housing 2120 can be configured to be retrofitted into a preexisting control drum cavity of a microreactor and to be driven by the control drum motion control system of the microreactor. Additionally, the neutron absorber section 2130 can be configured to absorb a substantial amount of power range neutrons produced by a fuel assembly of the microreactor. For example, the neutron absorber section 2130 can be comprised of a material having a high neutron cross-section, such as, for example, boron-10 based material and have a thickness of at least 1 millimeter. In some examples, the neutron absorber section 2130 comprises a first angular portion having a central angle of about 120° or less, or about 90° or less, or about 60°. A rotatable housing 2120 incorporating this configuration can be positioned at a location along a perimeter of a microreactor vessel and rotated by a preexisting drive system for a control drum to orient the first angular portion and/or the radially outer surface of the neutron absorber section in alignment with a central fuel assembly of a microreactor core to absorb a substantial amount of power range neutrons. A subsequent rotation of the rotatable housing to position the radially outer surface of the neutron absorber section furthest away from the central fuel assembly and facing the perimeter of the reactor vessel will not interact with as many neutrons and therefore, will not substantially decrease a reactivity within the reactor core.

Each of the one or more detector elements 2110 can be configured similarly to a detector element 1110 as described hereinabove. Thus, each of the one or more detector elements 2110 can be configured to be responsive to a source range and/or an intermediate range neutron flux. In some examples, each of the one or more detector elements 2110 can be affixed to the neutron absorber section 2130 and/or distributed along a length of the neutron absorber section 2130. Thus, each of the one or more detector elements 2110 can be configured to measure an axial power distribution within the microreactor core and/or vessel in a startup or a shutdown condition when the first angular portion of the rotatable housing 2120 is oriented in a first position facing the central fuel assembly.

Additionally, each of the one or more detector elements 2110 can be embedded into an outer surface of the neutron absorber section 2130 in a flush arrangement housing to avoid obstructing a rotation of the rotatable housing 2120 within a control drum cavity. Thus, the rotatable housing 2120 can be easily rotated to and/or from a second position where the detector elements 2110 are facing away from the central fuel assembly and a radially inner surface of the neutron absorber section 2130 can impede any propagation of a power range neutron flux from the central fuel assembly to the detector elements 2110. In some aspects, a control drum 2100 incorporating this configuration can simultaneously decrease reactivity of a reactor core and expose the detector elements to free neutrons in a first mode, and to shield the detector elements from harsh high power conditions without substantially decreasing reactivity of the reactor core in a second mode. Thus, in some aspects, the control drum 2100 can be configured to control the reactivity of a microreactor core for a planned operating lifetime of the nuclear fuel assembly therein, while maintaining a source range and/or intermediate range measurement sensitivity of the detector elements 2110 during high power reactor operating states, thereby providing the reliable lower power measurements required to safely control the microreactor core during transitions into startup and/or shutdown states thereof without requiring any substantial design changes to a preexisting instrumentation and control system for the control drums.

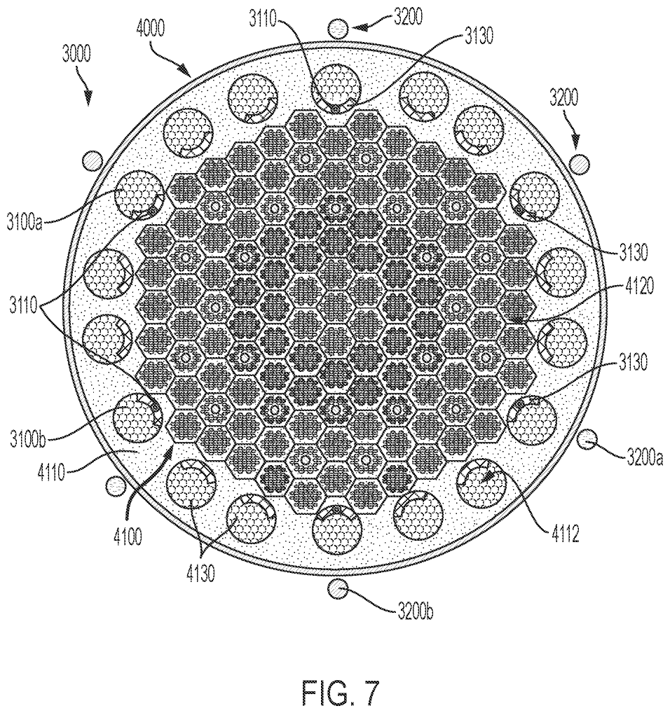

Now referring to FIG. 7, a cross-sectional view of a system 3000 for monitoring a power level of a core 4100 of a nuclear reactor vessel 4000 is provided, in accordance with at least one non-limiting aspect of the present disclosure. In various examples, the system 3000 includes a plurality of in-vessel detector assemblies 3100. The plurality of in-vessel detector assemblies 3100 are inserted into cavities 4112 of a neutron reflector assembly 4110 configured to surround a central fuel assembly 4120. In some examples, the system 3000 can include a plurality of ex-core detector assemblies 3200. In certain examples, the nuclear reactor vessel 4000 is a microreactor vessel.

Each of the in-vessel detector assemblies 3100 is similar in many respects to other in-vessel detector assemblies described elsewhere in the present disclosure which are not repeated for the sake of brevity. In various examples, each of the detector assemblies 3100 includes a neutron flux detection portion 3110 and is independently configured to rotate in place in a range of rotation. Each neutron flux detection portion 3110 can be configured similarly to a detector element 1110 as described hereinabove. Thus, each neutron flux detection portion 3110 can be configured to be responsive to a source range neutron flux, an intermediate range neutron flux or a combination thereof. In some examples, the system 3000 includes at least one in-vessel detector assembly 3100a comprising a source range neutron flux detection portion and at least one in-vessel detector 3100b assembly comprising an intermediate range neutron flux detection portion. Additionally, the system 3000 can include a plurality of ex-core detector assemblies 3200. Each of the ex-core detector assemblies is configured to be responsive to an upper intermediate range and/or a power range flux and is positioned outside of the reactor vessel 4000. In certain examples, the system 3000 includes at least three in-vessel detector assemblies 3100a, at least three in-vessel detector assemblies 3100b, at least three excore detector assemblies 3200a configured to detect an upper intermediate range neutron flux and at least three excore detector assemblies 3200b for detecting power range neutron flux. A system 3000 incorporating this configuration can provide accurate measurements at all power levels and overlapping regions therebetween. Thus, in some aspects, the system 3000 can be configured to measure a reactivity of a reactor core from complete shutdown up to 100% reactor power, or up to 120% reactor power, or up to accident condition power levels.

Each of the in-vessel detector assemblies 3100 can be configured similarly to an in-vessel detector assembly 1100 and/or a control drum 2100, as described hereinabove. In various examples, each of the in-vessel detector assemblies 3100 is independently configured to rotate in place in a range of rotation, each of the ranges of rotation defined by a number of angular sectors therein. Additionally, a first angular sector of each range of rotation is oriented towards an incident neutron flux from the core of the nuclear reactor. In some examples, each of the in-vessel detector assemblies 3100 includes a neutron absorber 3130. Each of the neutron flux detection portions 3110 can be embedded in an outer radial surface of a neutron absorber 3130. In certain examples, each of the neutron absorbers 3130 is configured with a neutron cross-section of the same order of magnitude as a neutron cross-section of a non-instrumented control drum. Thus, in some aspects, each of the in-vessel detector assemblies 3100 can be configured as an instrumented control drum. Accordingly, each of the in-vessel detector assemblies 3100 incorporating this configuration can replace a preexisting non-instrumented control drum in a microreactor to provide a reliable measurement of a source range and/or intermediate range neutron flux while maintaining a neutron absorption capacity of the non-instrumented control drum.

The system 3000 as described hereinabove can be incorporated into an existing reactivity control system of the reactor core including non-instrumented control drums 4130 to provide reliable measurements during a control sequence without sacrificing control responsiveness or requiring a dedicated I&C system. For example, FIGS. 7-10 illustrate various operating modes of the system 3000 according to at least one non-limiting aspect of the present disclosure. When a reactor 4000 is shutdown, the reactivity must be kept to a minimum by turning any available neutron absorber 3130 inward towards the central fuel assembly 4120, as depicted in FIG. 7, for example, thereby maintaining a subcritical reactor state.

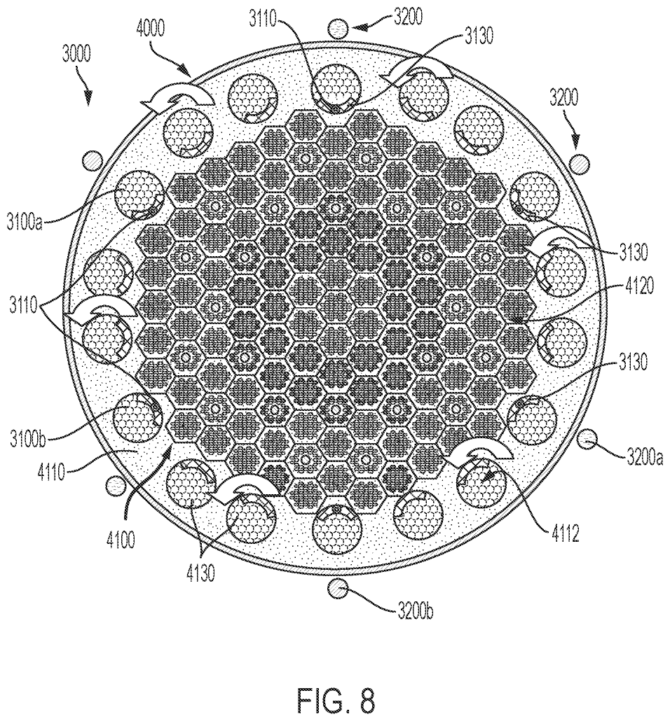

FIG. 8 depicts a source range startup state of the system 3000. The noninstrumented control drums 4130 begin to rotate away from the central fuel assembly 4120, thereby increasing the reactivity in the reactor core 4100 to provide a source range neutron flux therein. The in-vessel detector assemblies 3100a remain facing inwards to provide the measurement sensitivity required to reliably detect the source range neutrons. Although the intermediate level in-vessel detector assemblies 3100b are also facing inward during a low power startup, the neutron detection portions thereof do not substantially contribute to a neutron measurement due to their lack of neutron sensitivity to source range neutrons.

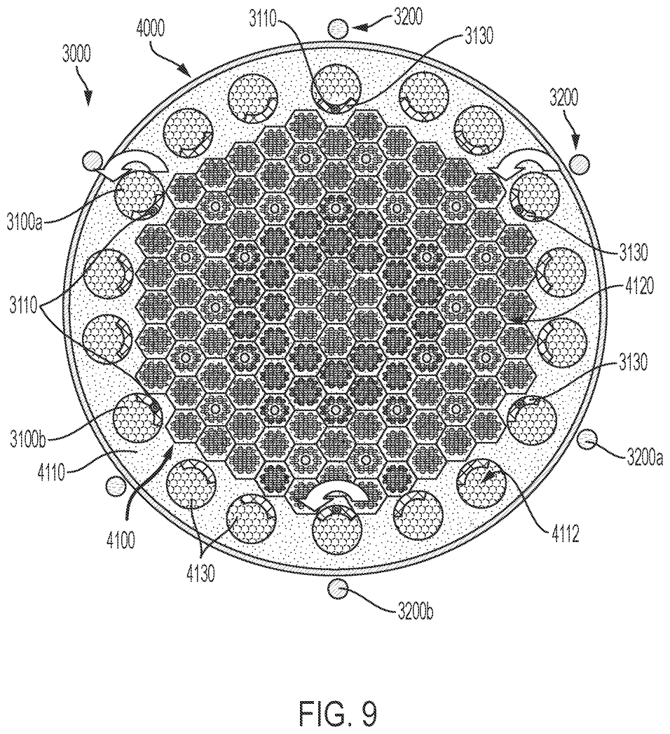

FIG. 9 depicts an intermediate range startup state of the system 3000. The noninstrumented control drums 4130 continue to rotate away from the central fuel assembly 4120, thereby increasing the reactivity in the reactor core 4100 from the source range startup state to an intermediate range power level. The source range in-vessel detector assemblies 3100a are rotated away from the central fuel assembly 4120, thereby shielding the sensitive neutron detection portions thereof from damaging intermediate range neutrons. However, the intermediate range in-vessel detector assemblies 3100b remain facing inwards to provide the measurement sensitivity required to reliably detect the intermediate range neutrons. Additionally, the excore assemblies 3200a begin to detect the intermediate neutrons.

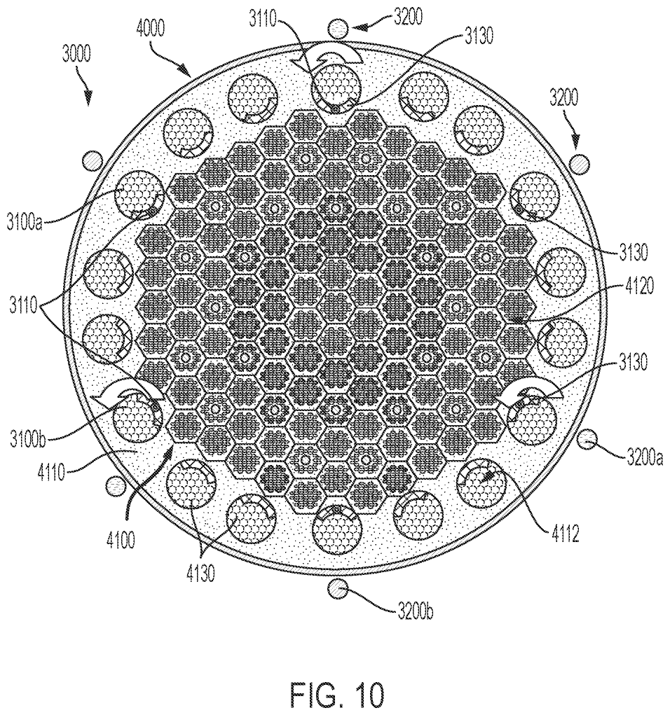

FIG. 10 depicts a reactor core 4100 producing full power. All of the neutron measurements in the full power setting are taken by excore assemblies 3200. All of the in-vessel detector assemblies 3100 and noninstrumented control drums 4130 are facing outward to minimize any absorption of neutrons, thereby allowing the central fuel assembly 4120 to provide power range neutrons. Additionally, the in-vessel detector assemblies 3100 are shielded from harsh power range neutrons in this orientation, thereby maintaining their measurement sensitivity while remaining within the reactor core 4100 to reliably provide measurements when a subsequent decrease in power must be initiated. Additionally, since the temperature inside the reactor vessel 4000 decreases with increasing distance from the central fuel assembly 4120, each of the neutron detection portions of the in-vessel detector assemblies 3100a and 3100b are positioned in the coolest regions of the reactor vessel 4000 during full power conditions. Accordingly, in some aspects, the system 3000 can be configured to protect the neutron detection portions of the in-vessel detector assemblies from high temperature and power range neutron exposure, thereby providing the benefit of extended working life of in-vessel detector assemblies 3100.

Various aspects of the present disclosure include, but are not limited to, the aspects listed in the following numbered clauses.
Clause 1—A measurement device for determining a power level of a nuclear reactor core. The measurement device comprises an in-vessel detector assembly. The in-vessel detector assembly comprises a housing defining a cavity therein, wherein the housing is configured to be rotatable in place, wherein the cavity of the housing comprises a first angular portion, and wherein a rotational range of the housing is comprised of a number of angular sectors. The in-vessel detector assembly further comprises a detector element positioned in the first angular portion of the cavity of the housing, wherein the detector element is configured to be responsive to a neutron flux upon an angular displacement of the first angular portion towards a first angular sector of the rotational range.
Clause 2—The measurement device of clause 1, wherein the in-vessel detector assembly is configured to remain within a cavity of the nuclear reactor core for the duration of a planned lifetime of a fuel assembly of the nuclear reactor core.
Clause 3—The measurement device of any one of clauses 1-2, wherein the nuclear reactor is a microreactor.
Clause 4—The measurement device of any one of clauses 1-3, wherein the in-vessel detector assembly is configured to remain within the cavity of the nuclear reactor core for about 8 years or longer.
Clause 5—The measurement device of any one of clauses 1-4, wherein the rotational range of the housing is about 180 degrees or more.
Clause 6—The measurement device of any one of clauses 1-5, wherein the detector element is embedded in the housing.
Clause 7—The measurement device of any one of clauses 1-6, wherein the housing comprises a neutron absorber, wherein the neutron absorber is positioned within the first angular portion of the housing.
Clause 8—The measurement device of clause 7, wherein the detector element is attached to the neutron absorber.
Clause 9—The measurement device of any one of clauses 7-8, wherein the detector element is embedded in an outermost radial portion of the neutron absorber.
Clause 10—The measurement device of any one of clauses 1-9, wherein the detector element is configured to be responsive to a source range neutron flux, an intermediate range neutron flux, or a combination thereof.
Clause 11—The measurement device of any one of clauses 1-10, wherein the in-vessel detector assembly is configured to shield the detector element from a neutron flux upon a rotation of the housing to align the first angular portion of the cavity of the housing with a second angular sector of the rotational range.
Clause 12—The measurement device of any one of clauses 1-11, wherein the housing is configured to be rotated by a drive for a control drum of the nuclear reactor.
Clause 13—A control drum for a nuclear reactor core. The control drum comprises a rotatable housing comprising a neutron absorber section and one or more detector elements configured to be responsive to a neutron flux. The rotatable housing is configured to rotate within a rotational range comprised of a number of angular sectors and the neutron absorber section is positioned within a first angular portion of the rotatable housing. The one or more detector elements are housed within the first angular portion of the rotatable housing.
Clause 14—The control drum of clause 13, wherein the one or more detector elements is affixed to the neutron absorber section.
Clause 15—The control drum of any one of clauses 13-14, wherein the control drum comprises a plurality of detector elements axially distributed along a length of the neutron absorber section.
Clause 16—The control drum of any one of clauses 13-15, wherein the one or more detector elements is embedded into an outer surface of the neutron absorber section.
Clause 17—The control drum of clause 16, wherein the one or more detector elements are flush with the outer surface of the neutron absorber section.
Clause 18—A system for monitoring a power level of a nuclear reactor, the system comprising a plurality of in-vessel detector assemblies. Each of the in-vessel detector assemblies comprises a neutron flux detection portion responsive to a source range neutron flux, an intermediate range neutron flux or a combination thereof. Each of the in-vessel detector assemblies is independently configured to be rotated in place through a rotational range by a control drum drive of the nuclear reactor, each rotational range comprising a number of angular sectors. The system is configured to independently determine a rotation of each of the in-vessel detector assemblies based on a neutron flux level within the nuclear reactor, wherein a rotation of an in-vessel detector assembly comprises an alignment of the neutron flux detection portion thereof with one of the angular sectors of the rotational range of the in-vessel detector assembly.
Clause 19—The system of clause 18, wherein the system comprises at least one in-vessel detector assembly comprising a source range neutron flux detection portion and at least one in-vessel detector assembly comprising an intermediate range neutron flux detection portion.
Clause 20—The system of any one of clauses 18-19, wherein each of the plurality of in-vessel detector assemblies is configured as an instrumented control drum, wherein each in-vessel detector assembly comprises a neutron absorber, and wherein each of the neutron flux detection portions is embedded in an outer radial surface of the neutron absorber.

Various features and characteristics are described in this specification to provide an understanding of the composition, structure, production, function, and/or operation of the disclosure, which includes the disclosed methods and systems. It is understood that the various features and characteristics of the disclosure described in this specification can be combined in any suitable manner, regardless of whether such features and characteristics are expressly described in combination in this specification. The Inventors and the Applicant expressly intend such combinations of features and characteristics to be included within the scope of the disclosure described in this specification. As such, the claims can be amended to recite, in any combination, any features and characteristics expressly or inherently described in, or otherwise expressly or inherently supported by, this specification. Furthermore, the Applicant reserves the right to amend the claims to affirmatively disclaim features and characteristics that may be present in the prior art, even if those features and characteristics are not expressly described in this specification. Therefore, any such amendments will not add new matter to the specification or claims and will comply with the written description, sufficiency of description, and added matter requirements.

With respect to the appended claims, those skilled in the art will appreciate that recited operations therein may generally be performed in any order. Also, although various operational flows are presented in a sequence(s), it should be understood that the various operations may be performed in other orders than those that are illustrated or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

The invention(s) described in this specification can comprise, consist of, or consist essentially of the various features and characteristics described in this specification. The terms “comprise” (and any form of comprise, such as “comprises” and “comprising”), “have” (and any form of have, such as “has” and “having”), “include” (and any form of include, such as “includes” and “including”), and “contain” (and any form of contain, such as “contains” and “containing”) are open-ended linking verbs. Thus, a method or system that “comprises,” “has,” “includes,” or “contains” a feature or features and/or characteristics possesses the feature or those features and/or characteristics but is not limited to possessing only the feature or those features and/or characteristics. Likewise, an element of a composition, coating, or process that “comprises,” “has,” “includes,” or “contains” the feature or features and/or characteristics possesses the feature or those features and/or characteristics but is not limited to possessing only the feature or those features and/or characteristics and may possess additional features and/or characteristics.

The grammatical articles “a,” “an,” and “the,” as used in this specification, including the claims, are intended to include “at least one” or “one or more” unless otherwise indicated. Thus, the articles are used in this specification to refer to one or more than one (i.e., to “at least one”) of the grammatical objects of the article. By way of example, “a component” means one or more components and, thus, possibly more than one component is contemplated and can be employed or used in an implementation of the described compositions, coatings, and processes. Nevertheless, it is understood that use of the terms “at least one” or “one or more” in some instances, but not others, will not result in any interpretation where failure to use the terms limits objects of the grammatical articles “a,” “an,” and “the” to just one. Further, the use of a singular noun includes the plural, and the use of a plural noun includes the singular, unless the context of the usage requires otherwise.

In this specification, unless otherwise indicated, all numerical parameters are to be understood as being prefaced and modified in all instances by the term “about,” in which the numerical parameters possess the inherent variability characteristic of the underlying measurement techniques used to determine the numerical value of the parameter. At the very least, and not as an attempt to limit the application of the doctrine of equivalents to the scope of the claims, each numerical parameter described herein should at least be construed in light of the number of reported significant digits and by applying ordinary rounding techniques.

Any numerical range recited herein includes all sub-ranges subsumed within the recited range. For example, a range of “1 to 10” includes all sub-ranges between (and including) the recited minimum value of 1 and the recited maximum value of 10, that is, having a minimum value equal to or greater than 1 and a maximum value equal to or less than 10. Also, all ranges recited herein are inclusive of the end points of the recited ranges. For example, a range of “1 to 10” includes the end points 1 and 10. Any maximum numerical limitation recited in this specification is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited. All such ranges are inherently described in this specification.

As used in this specification, particularly in connection with layers, the terms “on,” “onto,” “over,” and variants thereof (e.g., “applied over,” “formed over,” “deposited over,” “provided over,” “located over,” and the like) mean applied, formed, deposited, provided, or otherwise located over a surface of a substrate but not necessarily in contact with the surface of the substrate. For example, a layer “applied over” a substrate does not preclude the presence of another layer or other layers of the same or different composition located between the applied layer and the substrate. Likewise, a second layer “applied over” a first layer does not preclude the presence of another layer or other layers of the same or different composition located between the applied second layer and the applied first layer.

Whereas particular examples of this disclosure have been described above for purposes of illustration, it will be evident to those skilled in the art that numerous variations of the details of the present disclosure may be made without departing from the disclosure as defined in the appended claims.

What is claimed is:

1. A measurement device for determining a power level of a nuclear reactor core, the measurement device comprising:
an in-vessel detector assembly comprising:
a housing defining a cavity therein, wherein the housing is configured to be rotatable in place, wherein the cavity of the housing comprises a first angular portion, and wherein a rotational range of the housing is comprised of a number of angular sectors; and
a detector element positioned in the first angular portion of the cavity of the housing, wherein the detector element is configured to be responsive to a neutron flux upon an angular displacement of the first angular portion towards a first angular sector of the rotational range.

2. The measurement device as claimed in claim 1, wherein the in-vessel detector assembly is configured to remain within a cavity of the nuclear reactor core for the duration of a planned lifetime of a fuel assembly of the nuclear reactor core.

3. The measurement device as claimed in claim 2, wherein the nuclear reactor is a microreactor.

4. The measurement device as claimed in claim 2, wherein the in-vessel detector assembly is configured to remain within the cavity of the nuclear reactor core for about 8 years or longer.

5. The measurement device as claimed in claim 1, wherein the rotational range of the housing is about 180 degrees or more.

6. The measurement device as claimed in claim 1, wherein the detector element is embedded in the housing.

7. The measurement device as claimed in claim 1, wherein the housing comprises a neutron absorber, wherein the neutron absorber is positioned within the first angular portion of the housing.

8. The measurement device as claimed in claim 7, wherein the detector element is attached to the neutron absorber.

9. The measurement device as claimed in claim 7, wherein the detector element is embedded in an outermost radial portion of the neutron absorber.

10. The measurement device as claimed in claim 1, wherein the detector element is configured to be responsive to a source range neutron flux, an intermediate range neutron flux, or a combination thereof.

11. The measurement device as claimed in claim 1, wherein the in-vessel detector assembly is configured to shield the detector element from a neutron flux upon a rotation of the housing to align the first angular portion of the cavity of the housing with a second angular sector of the rotational range.

12. The measurement device as claimed in claim 1, wherein the housing is configured to be rotated by a drive for a control drum of the nuclear reactor.

13. A control drum for a nuclear reactor core, the control drum comprising:
a rotatable housing comprising a neutron absorber section, wherein the rotatable housing is configured to rotate within a rotational range comprised of a number of angular sectors, and wherein the neutron absorber section is positioned within a first angular portion of the rotatable housing; and
one or more detector elements configured to be responsive to a neutron flux, wherein the one or more detector elements are housed within the first angular portion of the rotatable housing.

14. The control drum as claimed in claim 13, wherein the one or more detector elements is affixed to the neutron absorber section.

15. The control drum as claimed in claim 14, wherein the control drum comprises a plurality of detector elements axially distributed along a length of the neutron absorber section.

16. The control drum as claimed in claim 13, wherein the one or more detector elements is embedded into an outer surface of the neutron absorber section.

17. The control drum as claimed in claim 16, wherein the one or more detector elements are flush with the outer surface of the neutron absorber section.

18. A system for monitoring a power level of a nuclear reactor, the system comprising:
a plurality of in-vessel detector assemblies, wherein:
each of the in-vessel detector assemblies comprises a neutron flux detection portion responsive to a source range neutron flux, an intermediate range neutron flux or a combination thereof; and
each of the in-vessel detector assemblies is independently configured to be rotated in place through a rotational range by a control drum drive of the nuclear reactor, each rotational range comprising a number of angular sectors; and
wherein the system is configured to independently determine a rotation of each of the in-vessel detector assemblies based on a neutron flux level within the nuclear reactor, wherein a rotation of an in-vessel detector assembly comprises an alignment of the neutron flux detection portion thereof with one of the angular sectors of the rotational range of the in-vessel detector assembly.

19. The system as claimed in claim 18, wherein the system comprises:
at least one in-vessel detector assembly comprising a source range neutron flux detection portion; and
at least one in-vessel detector assembly comprising an intermediate range neutron flux detection portion.

20. The system as claimed in claim 18, wherein each of the plurality of in-vessel detector assemblies is configured as an instrumented control drum, wherein each in-vessel detector assembly comprises a neutron absorber, and wherein each of the neutron flux detection portions is embedded in an outer radial surface of the neutron absorber.
